(19) United States
(12) Patent Application Publication
(10) Pub. No.: US 2024/0313220 A1
(43) Pub. Date: Sep. 19, 2024

(54) LITHIUM ION BATTERY AND MANUFACTURING METHOD THEREOF

(71) Applicant: Thomas Gerhard Wilhelm Damitz, Qingdao (CN)

(72) Inventor: Thomas Gerhard Wilhelm Damitz, Qingdao (CN)

(21) Appl. No.: 18/576,583

(22) PCT Filed: Jul. 4, 2022
(86) PCT No.: PCT/CN2022/103627

§ 371 Date: Jan. 4, 2024

(30) Foreign Application Priority Data
Jul. 5, 2021 (CN) 202110755849.X

(51) Int. Cl. H01M 4/62; H01M 4/04

(52) U.S. Cl. CPC H01M 4/621; H01M 4/043; H01M 4/0471

(57) ABSTRACT

Provides a lithium ion battery and a manufacturing method thereof. The lithium ion battery includes: a positive active material; a negative active material disposed opposite to the positive active material; a separator and an electrolyte disposed between the positive active material and the negative active material; and a case encapsulating the positive active material, the negative active material, the separator and the electrolyte; wherein the positive active material and the negative active material are attached to the separator by a coating layer. In the embodiments, the positive active material and the negative active material are attached to the separator by using a coating layer. Therefore, the positive active material, the negative active material, the coating layer and the separator can be bonded together directly or bonded together by a hot-press formation process, forming an integral structure.

### RELATED APPLICATIONS

The present application claims the benefit of Chinese Patent Application No. 202110755849.X, filed on Jul. 5, 2021, the entire disclosures of which are incorporated herein by reference.

### TECHNICAL FIELD

The present invention relates to the field of battery, and in particular, to a lithium ion battery and a manufacturing method thereof.

### BACKGROUND

Rechargeable lithium ion batteries (i.e., secondary lithium ion batteries) generally include one or more electrochemical cells having a negative electrode, a positive electrode, and an electrolyte for conducting lithium ions between the negative and positive electrodes. A porous separator wetted with a liquid electrolyte solution may be sandwiched between the electrodes to physically separate and electrically insulate the electrodes from each other while permitting free ion flow. Each of the negative and positive electrodes is typically carried on or connected to a metallic current collector. The current collectors may be connected to each other by an interruptible external circuit through which electrons can pass from one electrode to the other while lithium ions migrate in the opposite direction through the electrochemical cell during charging and discharging of the battery.

During discharging, the negative electrode contains a relatively high concentration of intercalated lithium, which is oxidized into lithium ions and electrons. The lithium ions travel from the negative electrode (cathode) to the positive electrode (anode), for example, through the ionically conductive electrolyte solution contained within the pores of the interposed porous polymeric separator. At the same time, the electrons pass through the external circuit from the negative electrode to the positive electrode. The lithium ions are assimilated into the positive active material by an electrochemical reduction reaction. The battery may be recharged after a partial or full discharge of its available capacity by an external power source, which reverses the electrochemical reactions that transpired during discharging.

During recharging, intercalated lithium in the positive electrode is oxidized into lithium ions and electrons. The lithium ions travel from the positive electrode to the negative electrode through the porous separator via the electrolyte, and the electrons pass through the external circuit to the negative electrode. The lithium cations are reduced to elemental lithium at the negative electrode and stored in the negative active material for reuse.

### SUMMARY

The invention provides a lithium ion battery and a manufacturing method thereof, which avoids the lithium ion battery becoming soft due to temperature change during fast charging and fast discharging, thereby improving the cycle life of the lithium ion battery.

In an aspect of the present invention, a lithium ion battery is provided. The lithium ion battery includes: a positive active material; a negative active material disposed opposite to the positive active material; a separator and an electrolyte disposed between the positive active material and the negative active material; and a case encapsulating the positive active material, the negative active material, the separator and the electrolyte; wherein the positive active material and the negative active material are attached to the separator by a coating layer.

Optionally, in some embodiments, a material of the coating layer includes at least one of polyvinylidene fluoride, styrene butadiene rubber, and an aqueous gel.

Optionally, in some embodiments, the positive active material and/or the negative active material include a thermosetting resin.

Optionally, in some embodiments, the coating layer includes a first film layer located between the separator and the positive active material and a second film layer located between the separator and the negative active material.

Optionally, in some embodiments, a thickness of the first film layer and a thickness of the second film layer are in a range of 0.5 micrometer to 1 micrometer.

Optionally, in some embodiments, the positive active material, the negative active material, the coating layer and the separator are bonded together by performing a hot-press formation process.

Optionally, in some embodiments, a temperature of the hot-press formation process is in a range of 40° C. to 80° C.

Optionally, in some embodiments, the positive active material includes at least one of lithium manganite (LiMn₂O₄), lithium cobaltate (LiCoO₂), lithium nickel cobalt manganese oxide (LiNiMnCoO₂), and lithium iron phosphate (LiFePO₄).

Optionally, in some embodiments, the negative active material includes at least one of graphite, a mixture of graphite and silicon, titanium dioxide (TiO₂), and lithium titanate (Li₄Ti₅O₁₂).

In another aspect of the present invention, a method for manufacturing a lithium ion battery is provided. The method includes: preparing a positive active material and a negative active material; attaching the positive active material and the negative active material to a separator by using a coating layer; arranging an electrolyte between the positive active material and the negative active material; and encapsulating the positive active material, the negative active material, the separator and the electrolyte with a case.

Optionally, in some embodiments, a material of the coating layer includes at least one of polyvinylidene fluoride, styrene butadiene rubber, and an aqueous gel.

Optionally, in some embodiments, before the step of attaching the positive active material and the negative active material to the separator using the coating layer, the method further includes: disposing the coating layer on a surface of the separator.

Optionally, in some embodiments, before the step of attaching the positive active material and the negative active material to the separator using the coating layer, the method further includes: disposing the coating layer on a surface of the positive active material and a surface of the negative active material.

Optionally, in some embodiments, the positive active material and/or the negative active material include a thermosetting resin.

Optionally, in some embodiments, the coating layer includes a first film layer located between the separator and the positive active material and a second film layer located between the separator and the negative active material.

Optionally, in some embodiments, a thickness of the first film layer and a thickness of the second film layer are in a range of 0.5 micrometer to 1 micrometer.

Optionally, in some embodiments, the method further includes: bonding the positive active material, the negative active material, the coating layer and the separator together by performing a hot-press formation process.

Optionally, in some embodiments, a temperature of the hot-press formation process is in a range of 40° C. to 80° C.

Optionally, in some embodiments, the positive active material includes at least one of lithium manganite (LiMn₂O₄), lithium cobaltate (LiCoO₂), lithium nickel cobalt manganese oxide (LiNiMnCoO₂), and lithium iron phosphate (LiFePO₄).

Optionally, in some embodiments, the negative active material includes at least one of graphite, a mixture of graphite and silicon, titanium dioxide (TiO₂), and lithium titanate (Li₄Ti₅O₁₂).

### BRIEF DESCRIPTION OF THE DRAWINGS

In order to more clearly illustrate the technical solutions in embodiments of the invention or in the prior art, the appended drawings needed to be used in the description of the embodiments or the prior art will be introduced briefly in the following. Obviously, the drawings in the following description are only some embodiments of the invention, and for those of ordinary skills in the art, other drawings may be obtained according to these drawings under the premise of not paying out creative work.

FIG. 1 is a schematic diagram of a lithium ion battery according to an embodiment of the present invention; and

FIG. 2 is a flow chart of a method for manufacturing a lithium ion battery according to an embodiment of the present invention.

### DETAILED DESCRIPTION OF THE INVENTION

In the following, the technical solutions in embodiments of the invention will be described clearly and completely in connection with the drawings in the embodiments of the invention. Obviously, the described embodiments are only part of the embodiments of the invention, and not all of the embodiments. Based on the embodiments in the invention, all other embodiments obtained by those of ordinary skills in the art under the premise of not paying out creative work pertain to the protection scope of the invention.

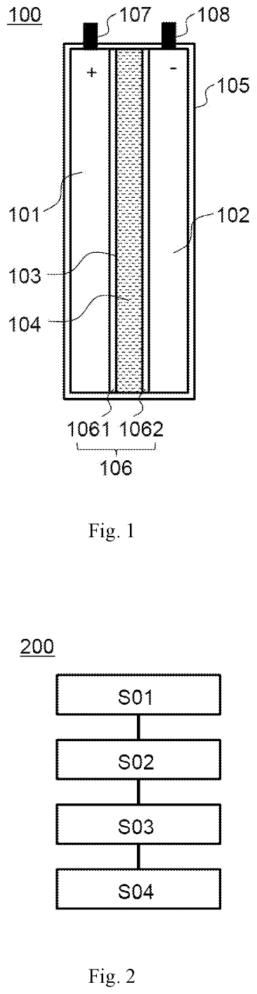

In an aspect of the present invention, a lithium ion battery is provided. Referring to FIG. 1, the lithium ion battery 100 includes: a positive active material 101; a negative active material 102 disposed opposite to the positive active material 101; a separator 103 and an electrolyte 104 disposed between the positive active material 101 and the negative active material 102; and a case 105 encapsulating the positive active material 101, the negative active material 102, the separator 103 and the electrolyte 104; wherein the positive active material 101 and the negative active material 102 are attached to the separator 103 by a coating layer 106.

In the embodiments of the invention, the positive active material and the negative active material are attached to the separator by using a coating layer. Therefore, the positive active material, the negative active material, the coating layer and the separator can be bonded together directly or bonded together by a hot-press formation process, forming an integral structure, which avoids the lithium ion battery becoming soft due to temperature change during the fast charging and fast discharging process, thereby improving the cycle life of the lithium ion battery.

Those skilled in the art will appreciate that, as shown in FIG. 1, the lithium ion battery 100 may further include a positive electrode tab 107 and a negative electrode tab 108 for connecting an external circuit.

Optionally, in some embodiments, a material of the coating layer includes at least one of polyvinylidene fluoride (PVDF), styrene butadiene rubber (SBR), and an aqueous gel.

Optionally, in some embodiments, the positive active material and/or the negative active material include a thermosetting resin.

The positive active material and/or the negative active material may include a thermosetting resin. Therefore, when the hot-press formation process is performed on the packaged battery, the thermosetting resin can form a crosslinked network in the positive electrode active material and/or the negative electrode active material, improving the strength of the positive electrode active material and/or the negative electrode active material. Further, the thermosetting resin can also form a stronger adhesion between the positive (negative) electrode active material and the separator when the hot-press formation process is performed on the packaged battery. Alternatively, the thermosetting resin may include at least one of polystyrene, polycarbonate, and silicone resin.

Optionally, in some embodiments, as shown in FIG. 1, the coating layer 106 includes a first film layer 1061 disposed between the separator 103 and the positive active material 101 and a second film layer 1062 disposed between the separator 103 and the negative active material 102.

Optionally, in some embodiments, a thickness of the first film layer 1061 and a thickness of the second film layer 1062 are in a range of 0.5 micrometer to 1 micrometer.

With the first film layer 1061 and the second film layer 1062 respectively disposed on both sides of the separator 103, the positive active material 101, the separator 103, and the negative active material 102 can be more effectively bonded together, enhancing the overall strength.

Optionally, in some embodiments, the positive active material, the negative active material, the coating layer and the separator are bonded together by performing a hot-press formation process.

Optionally, in some embodiments, a temperature of the hot-press formation process is in a range of 40° C. to 80° C.

The positive active material and the negative active material can be bonded to the separator via the coating layer using the temperature and the pressure of the hot-press formation process, thereby achieving a stable integral structure.

Optionally, in some embodiments, the positive active material includes at least one of lithium manganite (LiMn₂O₄), lithium cobaltate (LiCoO₂), lithium nickel cobalt manganese oxide (LiNiMnCoO₂), and lithium iron phosphate (LiFePO₄).

Optionally, in some embodiments, the negative active material includes at least one of graphite, a mixture of graphite and silicon, titanium dioxide (TiO₂), and lithium titanate (Li₄Ti₅O₁₂).

In another aspect of the present invention, a method for manufacturing a lithium ion battery is provided. Referring to FIG. 2, the method 200 includes the following steps: S01 preparing a positive active material and a negative active material; S02 attaching the positive active material and the negative active material to a separator by using a coating layer; S03 arranging an electrolyte between the positive active material and the negative active material; and S04 encapsulating the positive active material, the negative active material, the separator and the electrolyte with a case.

In the embodiments of the invention, the positive active material and the negative active material are attached to the separator by using a coating layer. Therefore, the positive active material, the negative active material, the coating layer and the separator can be bonded together directly or bonded together by a hot-press formation process, forming an integral structure, which avoids the lithium ion battery becoming soft due to temperature change during the fast charging and fast discharging process, thereby improving the cycle life of the lithium ion battery.

Optionally, in some embodiments, a material of the coating layer includes at least one of polyvinylidene fluoride, styrene butadiene rubber, and an aqueous gel.

Optionally, in some embodiments, before the step of attaching the positive active material and the negative active material to the separator using the coating layer, the method further includes: disposing the coating layer on a surface of the separator.

Optionally, in some embodiments, before the step of attaching the positive active material and the negative active material to the separator using the coating layer, the method further includes: disposing the coating layer on a surface of the positive active material and a surface of the negative active material.

Optionally, in some embodiments, the positive active material and/or the negative active material include a thermosetting resin.

The positive active material and/or the negative active material may include a thermosetting resin. Therefore, when the hot-press formation process is performed on the packaged battery, the thermosetting resin can form a crosslinked network in the positive electrode active material and/or the negative electrode active material, improving the strength of the positive electrode active material and/or the negative electrode active material. Further, the thermosetting resin can also form a stronger adhesion between the positive (negative) electrode active material and the separator when the hot-press formation process is performed on the packaged battery. Alternatively, the thermosetting resin may include at least one of polystyrene, polycarbonate, and silicone resin.

Optionally, in some embodiments, as shown in FIG. 1, the coating layer 106 includes a first film layer 1061 disposed between the separator 103 and the positive active material 101 and a second film layer 1062 disposed between the separator 103 and the negative active material 102.

Optionally, in some embodiments, a thickness of the first film layer 1061 and a thickness of the second film layer 1062 are in a range of 0.5 micrometer to 1 micrometer.

With the first film layer 1061 and the second film layer 1062 respectively disposed on both sides of the separator 103, the positive active material 101, the negative active material 102, the coating layer and the separator 103 can be more effectively bonded together, enhancing the overall strength.

Optionally, in some embodiments, the method further includes: bonding the positive active material, the negative active material, the coating layer and the separator together by performing a hot-press formation process.

Optionally, in some embodiments, a temperature of the hot-press formation process is in a range of 40° C. to 80° C.

The positive active material and the negative active material can be bonded to the separator via the coating layer using the temperature and the pressure of the hot-press formation process, thereby achieving a stable integral structure.

Optionally, in some embodiments, the positive active material includes at least one of lithium manganite (LiMn₂O₄), lithium cobaltate (LiCoO₂), lithium nickel cobalt manganese oxide (LiNiMnCoO₂), and lithium iron phosphate (LiFePO₄).

Optionally, in some embodiments, the negative active material includes at least one of graphite, a mixture of graphite and silicon, titanium dioxide (TiO₂), and lithium titanate (Li₄Ti₅O₁₂).

According to the lithium ion battery and the method for manufacturing the lithium ion battery, the positive active material and the negative active material are attached to the separator by using a coating layer. Therefore, the positive active material, the negative active material, the coating layer and the separator can be bonded together directly or bonded together by a hot-press formation process, forming an integral structure, which avoids the lithium ion battery becoming soft due to temperature change during the fast charging and fast discharging process, thereby improving the cycle life of the lithium ion battery.

The indefinite articles “a” and “an” as used herein in the specification and in the claims, unless clearly indicated to the contrary, should be understood to mean “at least one”.

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B”, or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising”, “including”, “carrying”, “having”, “containing”, “involving”, “holding”, “composed of” and the like are to be understood to be open-ended, i.e., to mean including but not limited to. Only the transitional phrases “consisting of” and “consisting essentially of” shall be closed or semi-closed transitional phrases, respectively.

The above embodiments are only used for explanations rather than limitations to the present invention, the ordinary skilled person in the related technical field, in the case of not departing from the spirit and scope of the present invention, may also make various modifications and variations, therefore, all the equivalent solutions also belong to the scope of the present invention, the patent protection scope of the present invention should be defined by the claims.

1. A lithium ion battery, comprising:
a positive active material;
a negative active material disposed opposite to the positive active material;
a separator and an electrolyte disposed between the positive active material and the negative active material; and
a case encapsulating the positive active material, the negative active material, the separator and the electrolyte;
wherein the positive active material and the negative active material are attached to the separator by a coating layer.

2. The lithium ion battery according to claim 1, wherein a material of the coating layer comprises at least one of polyvinylidene fluoride, styrene butadiene rubber, and an aqueous gel.

3. The lithium ion battery according to claim 1, wherein the positive active material and/or the negative active material comprise a thermosetting resin.

4. The lithium ion battery according to claim 1, wherein the coating layer comprises a first film layer located between the separator and the positive active material and a second film layer located between the separator and the negative active material.

5. The lithium ion battery according to claim 1, wherein a thickness of the first film layer and a thickness of the second film layer are in a range of 0.5 micrometer to 1 micrometer.

6. The lithium ion battery according to claim 1, wherein positive active material, the negative active material, the coating layer and the separator are bonded together by performing a hot-press formation process.

7. The lithium ion battery according to claim 6, wherein a temperature of the hot-press formation process is in a range of 40° C. to 80° C.

8. The lithium ion battery according to claim 1, wherein the positive active material comprises at least one of lithium manganate, lithium cobaltate, lithium nickel cobalt manganese oxide, and lithium iron phosphate.

9. The lithium ion battery according to claim 1, wherein the negative active material comprises at least one of graphite, a mixture of graphite and silicon, titanium dioxide, and lithium titanate.

10. A method for manufacturing a lithium ion battery, comprising:
preparing a positive active material and a negative active material;
attaching the positive active material and the negative active material to a separator by using a coating layer;
arranging an electrolyte between the positive active material and the negative active material; and
encapsulating the positive active material, the negative active material, the separator and the electrolyte with a case.

11. The method according to claim 10, wherein a material of the coating layer comprises at least one of polyvinylidene fluoride, styrene butadiene rubber, and an aqueous gel.

12. The method according to claim 10, wherein before the step of attaching the positive active material and the negative active material to the separator using the coating layer, the method further comprises: disposing the coating layer on a surface of the separator.

13. The method according to claim 10, wherein before the step of attaching the positive active material and the negative active material to the separator using the coating layer, the method further comprises: disposing the coating layer on a surface of the positive active material and a surface of the negative active material.

14. The method according to claim 10, wherein the positive active material and/or the negative active material comprise a thermosetting resin.

15. The method according to claim 10, wherein the coating layer includes a first film layer located between the separator and the positive active material and a second film layer located between the separator and the negative active material.

16. The method according to claim 15, wherein a thickness of the first film layer and a thickness of the second film layer are in a range of 0.5 micrometer to 1 micrometer.

17. The method according to claim 10, further comprising: bonding the positive active material, the negative active material, the coating layer and the separator together by performing a hot-press formation process.

18. The method according to claim 17, wherein a temperature of the hot-press formation process is in a range of 40° C. to 80° C.

19. The method according to claim 10, wherein the positive active material comprises at least one of lithium manganate, lithium cobaltate, lithium nickel cobalt manganese oxide, and lithium iron phosphate.

20. The method according to claim 10, wherein the negative active material comprises at least one of graphite, a mixture of graphite and silicon, titanium dioxide, and lithium titanate.
